(19) United States
(12) Patent Application Publication
(10) Pub. No.: US 2025/0191041 A1
(43) Pub. Date: Jun. 12, 2025

(54) Selecting Item Images for an Online Shopping Concierge Platform

(71) Applicant: Maplebear Inc., San Francisco, CA (US)

(72) Inventors: Saurav Manchanda, Seattle, WA (US); Prithvishankar Srinivasan, Seattle, WA (US); Shih-Ting Lin, Santa Clara, CA (US); Shishir Kumar Prasad, Fremont, CA (US); Min Xie, Santa Clara, CA (US)

(21) Appl. No.: 18/532,541

(22) Filed: Dec. 7, 2023

(51) Int. Cl. G06Q 30/0601

(52) U.S. Cl. CPC G06Q 30/0613; G06Q 30/0643

(57) ABSTRACT

An online shopping concierge platform receives data indicating one or more customer interactions associated with a particular item offered by the online shopping concierge platform; identifies a plurality of different and distinct images of the particular item; generates, based at least in part on multiple different and distinct machine learning (ML) models and for each image of the plurality of different and distinct images, a composite score for the image; selects, based at least in part on its respective composite score, an image of the particular item to be presented to the customer; generates data describing a graphical user interface (GUI) comprising a listing of the particular item including the selected image; and communicates to a computing device associated with the customer the data describing the GUI such that the computing device associated with the customer renders and displays the listing.

### BACKGROUND

Online shopping concierge platforms may link shoppers or pickers with customers, enabling customers to request and receive items located at various remote geographic locations. To increase the efficiency, profitability, and/or feasibility of such platforms, one or more item images may be selected for presentation to customers, and/or the like.

### SUMMARY

In accordance with one or more aspects of the disclosure, a method may be performed at a computer system comprising a processor and a computer-readable medium. The method may include receiving, via a communication interface of the computer system and from a computing device associated with a customer of an online shopping concierge platform, data indicating one or more interactions of the customer with the online shopping concierge platform associated with a particular item offered by the online shopping concierge platform. The method may also include identifying, by the computer system and based at least in part on the data indicating the interaction(s), a plurality of different and distinct images of the particular item. The method may further include generating, by the computer system, based at least in part on multiple different and distinct machine learning (ML) models, and for each image of the plurality of different and distinct images of the particular item, a composite score for the image. The method may further include selecting, by the computer system, from amongst the plurality of different and distinct images of the particular item, and based at least in part on its respective composite score, an image of the particular item to be presented to the customer. The method may further include generating, by the computer system, data describing a graphical user interface (GUI) comprising a listing of the particular item including the image of the particular item to be presented to the customer. The method may further include communicating, via the communication interface and to the computing device associated with the customer, the data describing the GUI such that the computing device associated with the customer renders and displays the listing of the particular item including the image of the particular item to be presented to the customer.

In accordance with one or more additional aspects of the disclosure, a system may comprise one or more processors, and a memory storing instructions that when executed by the processor(s) cause the system to perform operations. The operations may include generating, based at least in part on multiple different and distinct ML models and for each image of a plurality of different and distinct images of a particular item offered by an online shopping concierge platform, a composite score for the image. The operations may also include selecting, from amongst the plurality of different and distinct images of the particular item and based at least in part on its respective composite score, an image of the particular item to be presented to a customer of the online shopping concierge platform.

In accordance with one or more further aspects of the disclosure, one or more non-transitory computer-readable media may comprise instructions that when executed by one or more computing devices cause the computing device(s) to perform operations. The operations may include training, based at least in part on a corpus of multiple different and distinct images of multiple different and distinct items offered by an online shopping concierge platform, multiple different and distinct ML models to generate a composite score for each of multiple different and distinct images of a particular item offered by the online shopping concierge platform. The operations may also include selecting, from amongst the multiple different and distinct images of the particular item offered by the online shopping concierge platform, an image of the particular item based at least in part on its respective composite score generated based at least in part on the multiple different and distinct ML models.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example GUI for an online concierge system, in accordance with one or more embodiments.

FIG. 4 illustrates an example architecture for selecting item images for an online concierge system, in accordance with one or more embodiments.

FIG. 5 depicts one or more example methods for an online concierge system, in accordance with one or more embodiments.

### DETAILED DESCRIPTION

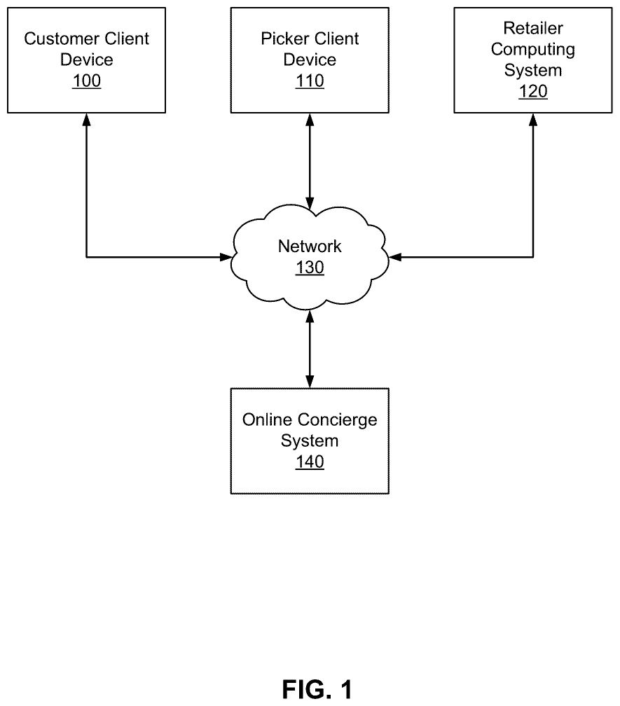

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

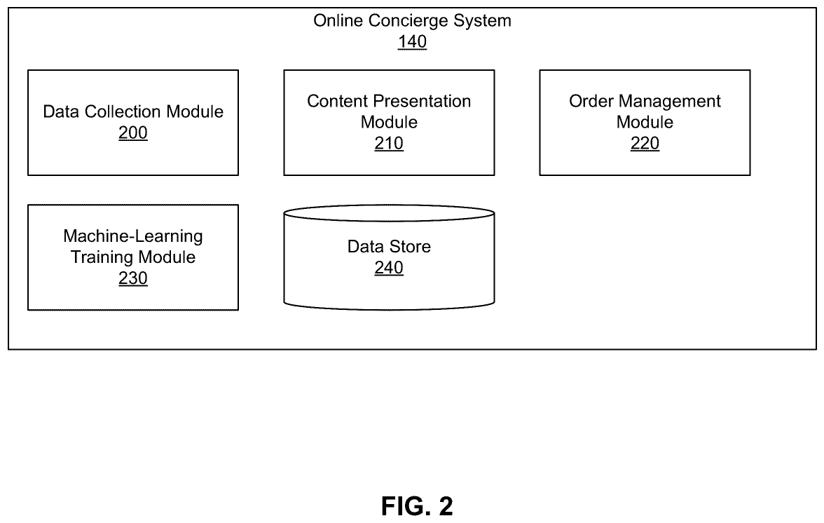

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100. For example, in collecting the item data, collection module 200 may collect data indicating such information, e.g., information or data that identifies and describes items that are available at a retailer location, and/or the like.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140. For example, in collecting the picker data, data collection module 200 may collect data indicating such information, e.g., information or data that describes the characteristics of pickers, and/or the like.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. For example, in collecting the order data, data collection module 200 may collect data indicating such information, e.g., information or data that describes characteristics of an order, and/or the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

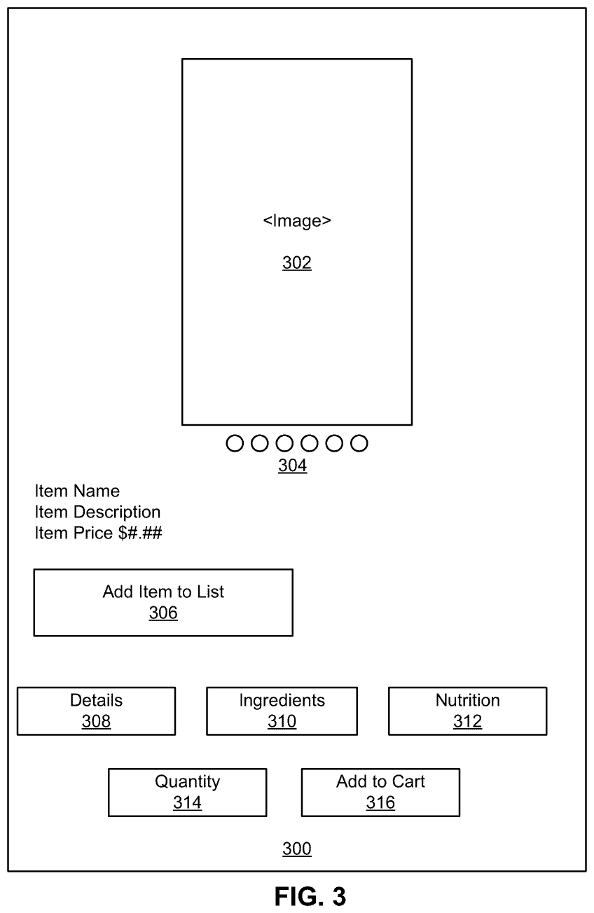

FIG. 3 illustrates an example GUI for an online concierge system, in accordance with one or more embodiments. Referring to FIG. 3, GUI 300 may comprise a listing for one or more particular items to be presented to a customer of the online shopping concierge platform. As illustrated, the listing may include one or more images 302 of the particular item(s). As will be described in greater detail below, in accordance with one or more embodiments of the subject matter described herein, such image(s) may be selected for inclusion in the listing based at least in part on composite scores generated for the image(s) based at least in part on multiple different and distinct ML models. GUI 300 may also include one or more elements 304 for switching between various different and distinct images and/or views of the particular item(s), and/or the like.

Additionally or alternatively, GUI 300 may include one or more elements for manipulating and/or interacting with the listing. For example, GUI 300 may include element 306 for adding one or more of the item(s) to a shopping list associated with the customer, element 308 for viewing additional information about one or more of the item(s), element 310 for viewing ingredient information for one or more of the item(s), element 312 for viewing nutritional information for one or more of the item(s), element 314 for adjusting a quantity of one or more of the item(s) to be purchased, element 316 for adding one or more of the item(s) to a shopping cart associated with the customer, and/or the like.

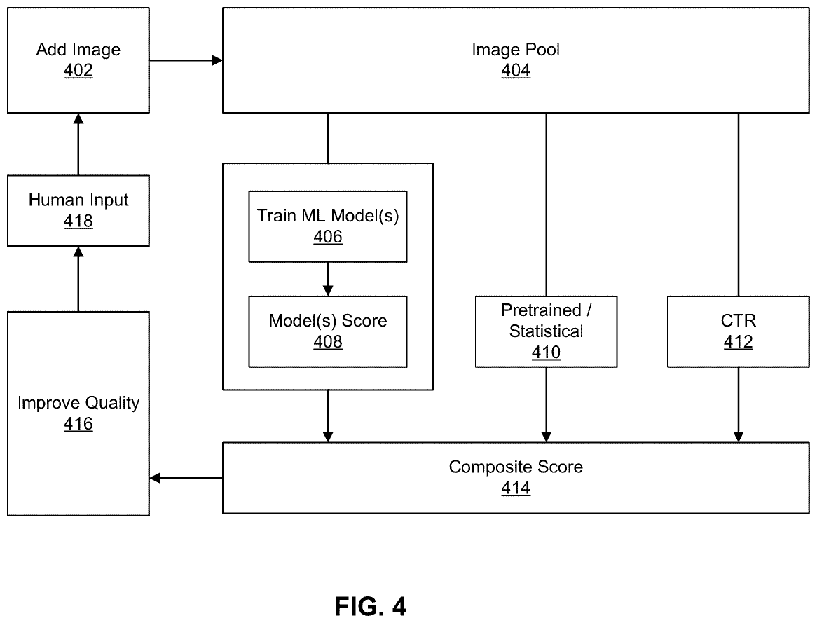

FIG. 4 illustrates an example architecture for selecting item images for an online concierge system, in accordance with one or more embodiments. Referring to FIG. 4, at (402), an image of an item offered by the online shopping concierge platform may be added to image pool 404. For example, the online shopping concierge platform may be offering a new item to its customers, and one or more images and/or views of the new item may be added to image pool 404, and/or the like. At (406), one or more ML models may be trained (e.g., based at least in part on the images in image pool 404, and/or the like) to generate one or more scores for item images, and/or the like. For example, one or more of such ML models may be configured to generate a value representing one or more measures of quality of the images, and/or the like. Additionally or alternatively, one or more of such ML models may be configured to generate a value representing one or more measures of a likelihood that a customer will engage with a listing if the image is included in the listing, and/or the like.

At (410), one or more pre-trained and/or statistical models may generate one or more additional values, for example, representing one or more measures of quality of the images, and/or the like. Similarly, at (412), one or more models (e.g., one or more click through rate (CTR) models, and/or the like) may generate one or more additional values, for example, representing one or more measures of the likelihood that the customer will engage with a listing if the image is included in the listing, and/or the like. At (414), a composite score for the image may be generated based at least in part on one or more of the values generated at (408), (410), (412), and/or the like.

At (416), a determination may be made to improve the quality of the image, for example, based at least in part on a determination that the composite score does not meet a threshold for the online shopping concierge platform, and/or the like. At (418), in some embodiments, human input may be received with respect to the improved image, and/or the like. At (402), the improved image may be added to image pool 404, and/or the like.

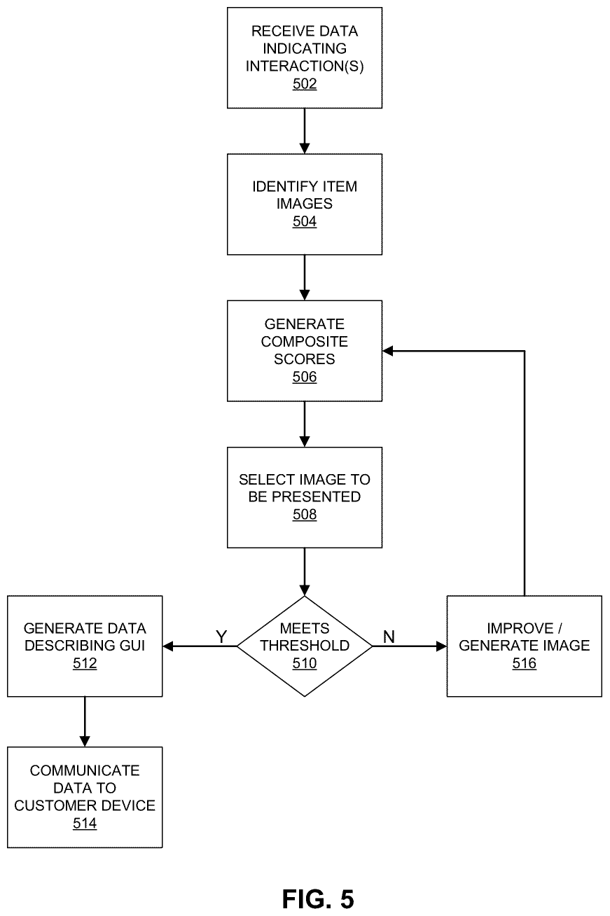

FIG. 5 depicts one or more example methods for an online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

At (502), at a computer system comprising a processor and a computer-readable medium (e.g., online concierge system 140, and/or the like), data indicating one or more interactions of a customer associated with a particular item offered by an online shopping concierge platform may be received (e.g., via a communication interface of the computer system, and/or the like) from a computing device associated with the customer of the online shopping concierge platform (e.g., customer client device 100, and/or the like). For example, online concierge system 140 may receive, from customer client device 100, data indicating a customer has viewed, purchased, indicated an interest in, and/or the like a particular food item, and/or the like.

At (504), the computer system may identify (e.g., based at least in part on the data indicating the interaction(s), and/or the like) a plurality of different and distinct images of the particular item. For example, online concierge system 140 may identify a plurality of different and distinct images, views, and/or the like of the particular food item.

At (506), the computer system may generate, based at least in part on multiple different and distinct ML models, and for each image of the plurality of different and distinct images of the particular item, a composite score for the image. For example, online concierge system 140 may generate, based at least in part on multiple different and distinct ML models, and for each image of the plurality of different and distinct images of the particular food item, a composite score for the image.

In some embodiments, generating the composite score may include generating at least one value representing one or more measures of quality of the image. For example, generating the at least one value representing the one or more measures of quality may include generating the at least one value based at least in part on one or more blind reference-less image spatial quality evaluator (BRISQUE) models, one or more natural image quality evaluator (NIQE) models, one or more perception-based image quality evaluator (PIQE) models, one or more pixel coverage scores, and/or the like. Additionally or alternatively, generating the at least one value representing the one or more measures of quality may include generating the at least one value based at least in part on one or more image-sharpness or -blurriness ML models trained based at least in part on a corpus of images of various different and distinct items offered by the online shopping concierge platform.

In some embodiments, generating the composite score may include generating at least one value representing one or more measures of a likelihood that the customer will engage with the listing if the image of the particular item is included in the listing. For example, generating the at least one value representing the one or more measures of the likelihood that the customer will engage with the listing may include generating the at least one value based at least in part on one or more ML models trained based at least in part on historical CTR data for a corpus of images of various different and distinct items offered by the online shopping concierge platform. Additionally or alternatively, generating the at least one value representing the one or more measures of the likelihood that the customer will engage with the listing may include generating the at least one value based at least in part on one or more ML models trained based at least in part on historical CTR data for the customer of the online shopping concierge platform.

At (508), the computer system may select, from amongst the plurality of different and distinct images of the particular item, and based at least in part on its respective composite score, an image of the particular item to be presented to the customer. In some embodiments, selecting the image of the particular item to be presented to the customer may include determining that the respective composite score for the image meets a predetermined threshold for the online shopping concierge platform. For example, at (510), the computer system may determine that the composite score for the image meets the predetermined threshold for the online shopping concierge platform. Responsive to determining that the composite score meets the predetermined threshold, at (512), the computer system may generate data describing a GUI comprising a listing of the particular item including the image of the particular item to be presented to the customer. At (514), the computer system may communicate the data describing the GUI such that the computing device associated with the customer renders and displays the listing of the particular item including the image of the particular item to be presented to the customer.

Returning to (510), responsive to determining that the composite score does not meet the predetermined threshold, at (516), the computer system may generate, based at least in part on one or more ML models, a modified version of the image for which a generated composite score meets the predetermined threshold for the online shopping concierge platform. In some embodiments, generating the modified version of the image may include generating the modified version of the image based at least in part on one or more generative artificial intelligence (AI) models. Additionally or alternatively, the computer system may select, based at least in part on the respective composite score for the image or one or more components of the respective composite score for the image, the one or more ML models based at least in part on which the modified version of the image is to be generated.

In some embodiments, the computer system may randomly select, from amongst the plurality of different and distinct images of the particular item, and irrespective of its respective generated composite score, an image of the particular item to be presented to the customer (e.g., to address one or more biases of the model(s), and/or the like).

In some embodiments, the computer system may generate, for each image of the plurality of different and distinct images of the particular item, and based at least in part on the composite score for the image and a view of the particular item depicted by the image, a priority score for the image. In some of such embodiments, the computer system may format the listing of the particular item to include multiple images of the particular item ordered within the listing based at least in part on their respective priority scores. Additionally or alternatively, the computer system may generate the priority score for the image based at least in part on historical engagement by the customer with images of other items offered by the online shopping concierge platform depicting the view. For example, if the customer is health conscious and has historically viewed images comprising nutritional information for items, the computer system may prioritize images including such nutritional information in the listing.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, via a communication interface of the computer system and from a computing device associated with a customer of an online shopping concierge platform, data indicating one or more interactions of the customer with the online shopping concierge platform associated with a particular item offered by the online shopping concierge platform;
identifying, by the computer system and based at least in part on the data indicating the one or more interactions, a plurality of different and distinct images of the particular item;
generating, by the computer system, based at least in part on multiple different and distinct machine learning (ML) models, and for each image of the plurality of different and distinct images of the particular item, a composite score for the image;
selecting, by the computer system, from amongst the plurality of different and distinct images of the particular item, and based at least in part on its respective composite score, an image of the particular item to be presented to the customer;
generating, by the computer system, data describing a graphical user interface (GUI) comprising a listing of the particular item including the image of the particular item to be presented to the customer; and
communicating, via the communication interface and to the computing device associated with the customer, the data describing the GUI such that the computing device associated with the customer renders and displays the listing of the particular item including the image of the particular item to be presented to the customer.

2. The method of claim 1, wherein generating the composite score comprises generating at least one value representing one or more measures of quality of the image.

3. The method of claim 2, wherein generating the at least one value representing the one or more measures of quality comprises generating the at least one value based at least in part on one or more blind reference-less image spatial quality evaluator (BRISQUE) models, one or more natural image quality evaluator (NIQE) models, one or more perception-based image quality evaluator (PIQE) models, or one or more pixel coverage scores.

4. The method of claim 2, wherein generating the at least one value representing the one or more measures of quality comprises generating the at least one value based at least in part on one or more image-sharpness or -blurriness ML models trained based at least in part on a corpus of images of various different and distinct items offered by the online shopping concierge platform.

5. The method of claim 1, wherein generating the composite score comprises generating at least one value representing one or more measures of a likelihood that the customer will engage with the listing if the image of the particular item is included in the listing.

6. The method of claim 5, wherein generating the at least one value representing the one or more measures of the likelihood that the customer will engage with the listing comprises generating the at least one value based at least in part on one or more ML models trained based at least in part on historical click through rate (CTR) data for a corpus of images of various different and distinct items offered by the online shopping concierge platform.

7. The method of claim 5, wherein generating the at least one value representing the one or more measures of the likelihood that the customer will engage with the listing comprises generating the at least one value based at least in part on one or more ML models trained based at least in part on historical click through rate (CTR) data for the customer of the online shopping concierge platform.

8. The method of claim 1, wherein selecting the image of the particular item to be presented to the customer comprises identifying that the respective composite score for the image meets a predetermined threshold for the online shopping concierge platform.

9. The method of claim 8, comprising, responsive to identifying, for at least one image of the plurality of different and distinct images of the particular item, that the composite score for the image does not meet the predetermined threshold for the online shopping concierge platform, generating, by the computer system and based at least in part on one or more ML models, a modified version of the image for which a generated composite score meets the predetermined threshold for the online shopping concierge platform.

10. The method of claim 9, wherein generating the modified version of the image comprises generating the modified version of the image based at least in part on one or more generative artificial intelligence (AI) models.

11. The method of claim 9, comprising selecting, by the computer system and based at least in part on the respective composite score for the image or one or more components of the respective composite score for the image, the one or more ML models based at least in part on which the modified version of the image is to be generated.

12. The method of claim 1, comprising:
receiving, via the communication interface of the computer system and from a different computing device associated with a different customer of the online shopping concierge platform, data indicating one or more interactions of the different customer with the online shopping concierge platform associated with a different particular item offered by the online shopping concierge platform;
identifying, by the computer system and based at least in part on the data indicating the one or more interactions of the different customer, a plurality of different and distinct images of the different particular item; and
randomly selecting, by the computer system, from amongst the plurality of different and distinct images of the different particular item, and irrespective of its respective generated composite score, an image of the different particular item to be presented to the different customer.

13. The method of claim 1, comprising:
generating, by the computer system, for each image of the plurality of different and distinct images of the particular item, and based at least in part on the composite score for the image and a view of the particular item depicted by the image, a priority score for the image; and
formatting, by the computer system, the listing of the particular item to include multiple images of the particular item ordered within the listing based at least in part on their respective priority scores.

14. The method of claim 13, wherein generating the priority score for the image comprises generating the priority score for the image based at least in part on historical engagement by the customer with images of other items offered by the online shopping concierge platform depicting the view.

15. A system comprising:
one or more processors; and
a memory storing instructions that when executed by the one or more processors cause the system to perform operations comprising:
generating, based at least in part on multiple different and distinct machine learning (ML) models and for each image of a plurality of different and distinct images of a particular item offered by an online shopping concierge platform, a composite score for the image; and
selecting, from amongst the plurality of different and distinct images of the particular item and based at least in part on its respective composite score, an image of the particular item to be presented to a customer of the online shopping concierge platform.

16. The system of claim 15, wherein generating the composite score comprises generating at least one value representing one or more measures of quality of the image.

17. The system of claim 15, wherein generating the composite score comprises generating at least one value representing one or more measures of a likelihood that the customer will engage with a listing if the image of the particular item is included in the listing.

18. The system of claim 15, wherein selecting the image of the particular item to be presented to the customer comprises identifying that the respective composite score for the image meets a predetermined threshold for the online shopping concierge platform.

19. The system of claim 15, wherein the operations comprise:
generating, for each image of the plurality of different and distinct images of the particular item and based at least in part on the composite score for the image and a view of the particular item depicted by the image, a priority score for the image; and
formatting a listing of the particular item to include multiple images of the particular item ordered within the listing based at least in part on their respective priority scores.

20. One or more non-transitory computer-readable media comprising instructions that when executed by one or more computing devices cause the one or more computing devices to perform operations comprising:
training, based at least in part on a corpus of multiple different and distinct images of multiple different and distinct items offered by an online shopping concierge platform, multiple different and distinct machine learning (ML) models to generate a composite score for each of multiple different and distinct images of a particular item offered by the online shopping concierge platform; and
selecting, from amongst the multiple different and distinct images of the particular item offered by the online shopping concierge platform, an image of the particular item based at least in part on its respective composite score generated based at least in part on the multiple different and distinct ML models.
